(19) United States
(12) Patent Application Publication
(10) Pub. No.: US 2015/0278760 A1
(43) Pub. Date: Oct. 1, 2015

(54) INTEGRATED PRIVATE OFFICE

(71) Applicants: Boris Greven, Weinheim (DE); Bernhard Graf, Neustadt (DE)

(72) Inventors: Boris Greven, Weinheim (DE); Bernhard Graf, Neustadt (DE)

(21) Appl. No.: 14/231,100

(22) Filed: Mar. 31, 2014

(51) Int. Cl. G06Q 10/10; G06Q 40/00

(52) U.S. Cl. CPC G06Q 10/10; G06Q 40/12

(57) ABSTRACT

Technologies are disclosed for providing integrated private office technologies. A wide variety of functionality across a variety of service providers can be provided via a single portal. On the consumer side, a single, integrated portal allows the consumer to manage contracts with different service providers across different industries. Information such as cash flow can be integrated to provide an overall picture across the consumer's affairs. Recurring payments can be integrated into a system that also supports reminders and the like. On the provider side, plug-ins can be utilized by which a great number of consumers can be reached, and the overall consumer experience is enhanced. Cloud technologies can make the portal available to a consumer from any location via a variety of device types.

### BACKGROUND

Although significant strides have been made in the area of electronic commerce, for many consumers, the realization of a paperless office still remains elusive. Many service providers now offer the option to do business electronically, but the consumer is sometimes left more disorganized and overwhelmed than ever.

For example, due to the ease at which a consumer can enter into relationships with new service providers, the number of relationships that need to be tracked has increased. It is not unusual for a consumer to be engaged in dozens of relationships with various providers.

Because each provider has a separate website and different conventions and communication techniques, the user is faced with having to manage the relationships separately. It is therefore difficult to manage them together, and easy to miss or misplace important information or dates for a particular provider.

In practical terms, some consumers are still printing out electronic communications and keeping them in paper files so they can continue to manage their accounts.

Thus, there is a need for technologies to help consumers better manage their provider relationships, within a paperless office at one place.

### SUMMARY

The summary is provided to introduce a selection of concepts in a simplified form that are further described below in the detailed description. The summary is not intended to identify key features or essential features of the claimed subject matter, nor is it intended to be used to limit the scope of the claimed subject matter.

An embodiment can be implemented as a method implemented at least in part by a computing system, the method comprising: maintaining a collection of consumer data for a plurality subscribing consumers; maintaining a collection of provider data for a plurality of participating providers; via an integrated private office portal, receiving an integrated private office operation request from a client via a cloud platform, wherein the operation request is associated with an integrated private office consumer identifier of a particular subscribing consumer; mapping the integrated private office consumer identifier to a consumer identifier of a particular one of the providers; via the consumer identifier of the particular one of the providers, performing the requested operation via one of a plurality of different plug-in types supported by the integrated private office portal; and providing a response to the integrated private office operation request to the client.

An embodiment can be implemented as a system comprising: one or more processors; and memory coupled to the one or more processors; a consumer information data collection for a plurality of subscribing consumers, wherein the consumer information collection is organized via an integrated private office consumer identifiers; a provider information data collection for a plurality of participating service providers; a mapping between the integrated private office consumer identifiers and consumer identifiers for particular of the participating service providers; representations of contracts between the subscribing consumers and the participating service providers; and a cash flow analysis engine configured to integrate payment information arising out of the contracts for a plurality of the service providers into a cash flow overview presentation.

An embodiment can be implemented as one or more computer-readable media having encoded therein computer-executable instructions causing a computing system to perform a method comprising: receiving payment information for a plurality of consumers on behalf of a plurality of service providers via a plurality of plug-in types; receiving communications targeted to the plurality of consumers on behalf of the plurality of service providers; receiving contract information for the plurality of service providers; receiving goods information for the plurality of consumers; integrating the payment information, communications, contract information, and goods information into an integrated private office portal, wherein the integrated private office portal provide a variety of functionality across contracts between the consumers and respective of the service providers, wherein the functionality comprises generating a user interface depicting projected cash flow over time via combining the payment information obtained via the plurality of plug-in types; providing a social media channel between a consumer and a service provider; storing electronic signatures for contracts entered into by the consumers; employing an industry-specific plug-in and a standard plug-in; providing paperless office functionality to the consumers; providing user interface customization functionality; and storing private business information for a consumer; whereby a consumer-centric approach is implemented.

### BRIEF DESCRIPTION OF THE DRAWINGS

FIG. 1 is a block diagram of an example system implementing an integrated private office portal.

FIG. 2 is a flowchart of an example method of implementing an integrated private office portal.

FIG. 3 is a block diagram of an example integrated private office system integrating a variety of information.

FIG. 4 is a flowchart of an example method implementing an integrated private office integrating a variety of information.

FIG. 5 is a block diagram of an example integrated private office portal implementing an industry-specific plug-in.

FIG. 6 is a flowchart of an example method implementing an integrated private office portal via an industry-specific plug-in.

FIG. 7 is a block diagram of an example architecture for an integrated private office portal.

FIG. 8 is an example configurable layout of a user interface for presenting an integrated private office.

FIG. 9 is a screen shot of an example cash flow user interface for presentation as part of an integrated private office.

FIG. 10 is a screen shot of an example cash flow user interface with a detail inset.

FIG. 11 is a screen shot of an example contracts overview user interface for presentation as part of an integrated private office.

FIG. 12 is a block diagram showing a mapping data structure used to resolve user identities for a single user across multiple providers.

FIG. 13 is a block diagram showing a contract record data structure.

FIG. 14 depicts a generalized example of a suitable computing environment in which the described innovations may be implemented.

FIG. 15 is an example cloud-support environment that can be used in conjunction with the technologies described herein.

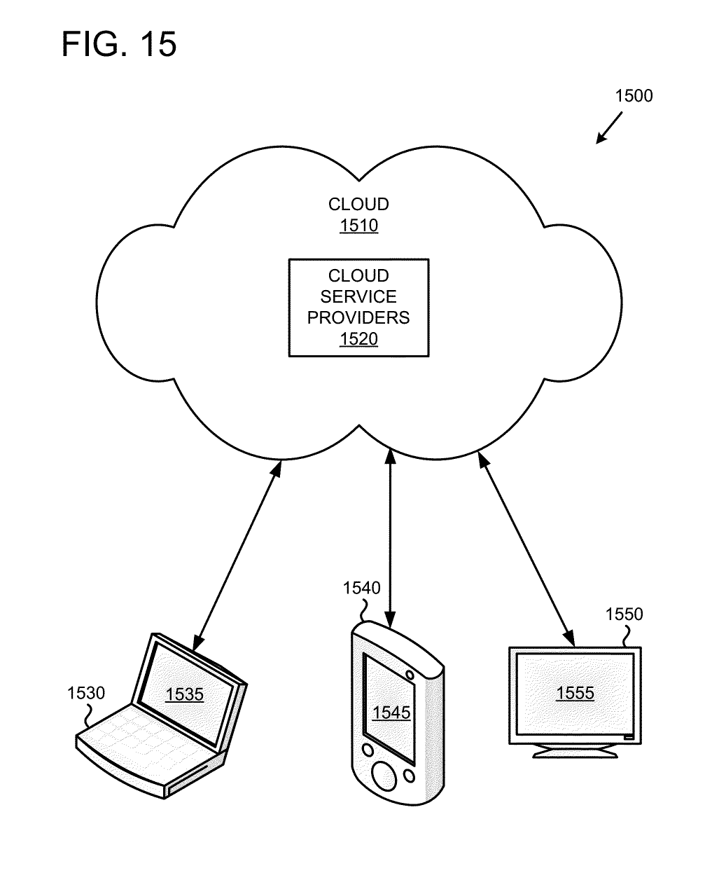

### DETAILED DESCRIPTION

### Example 1

### Overview

The technologies described herein can be used for a variety of integrated private office scenarios, and adoption of the technologies can provide improved techniques for managing relationships between consumers and service providers, including initiating new relationships. Contractual information for a single consumer can be put assembled and provided from a variety of different service providers across different industries in an electronic way.

In a digital world, the focus is on consumer behavior, which implies the ability to handle multi-provider relationships in a consumer-centric manner. The technologies can make the consumer's life easier and more structured from any location at any time.

A central view of contracts can be provided to greatly benefit a consumer when making decisions, managing finances, and the like. For example, cash flow can be accurately projected and visualized due to the inclusiveness of the technologies.

Any aspect of the integrated private office can be implemented and accessed via cloud technologies. For example, a consumer can use any of a variety of device types to access their integrated private office from any location with online connectivity.

Although other arrangements are possible, the integrated private office can be provided to consumers at little or no cost, and service providers can bear the costs of administration (e.g., via a managing party or other entity). In this way, a critical mass of consumers (e.g., customers) can be attracted, and service providers are motivated to participate.

Implementations can relieve consumers from maintaining a traditional paper office, and more transparency can be provided because information related to any contract can be managed in a variety of ways.

The integrated private office can also provide payment functionality so that consumers can easily make payments or plug in payment engines, for example. Furthermore, industry-specific plug-ins to allow communication between consumers and providers can be activated

As described herein, cash flow user interfaces can be provided that give a consumer a view into their cash flow. In addition, the user interface can be highly configurable and enhanceable; data of provides which do not use the integrated private office can be integrated.

The technologies can thus be helpful for those wishing to avoid having to expend resources visiting the sites of multiple providers and organizing such information in a paper-based or other way. Beneficiaries can also include service providers because they can easily communicate with their consumers. Costs for providers can be reduced through integrated and paperless information transfer as well as easy communication about private business.

The technologies described herein can be provided by a global service provider operating at a unique position in the market, providing an end-to-end solution from provider to consumer and vice versa. A large number of consumers can be reached. A variety of technologies can be combined by an independent software provider or other entity to deliver a superior level of service and user experience.

Other features including social media channels between consumer and provider, advertising, private budget, agreements, subscriptions, consume enhancements (e.g., if providers are not using the integrated private office), earnings, costs, investments, and the like can be included.

Various other features can be implemented and combined as described herein.

### Example 2

### Example System Implementing Integrated Private Office

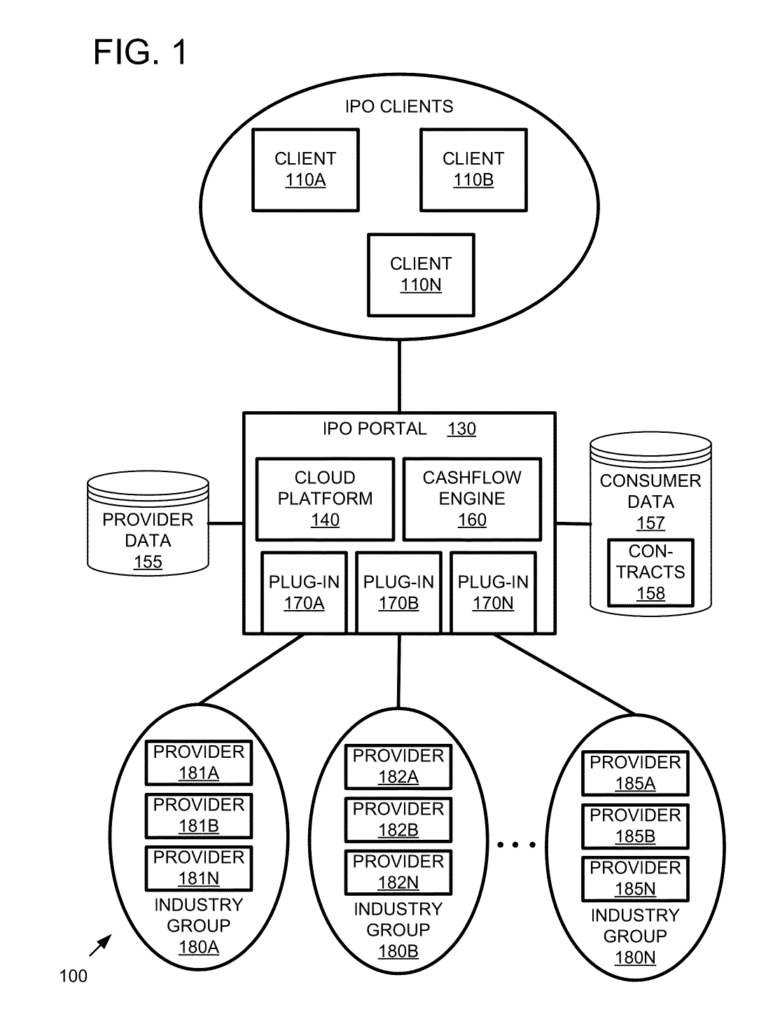

FIG. 1 is an illustrative overview of an example system 100 implementing an integrated private office technologies. In FIG. 1, an integrated private office portal 130 is in communication with a plurality of integrated private office client applications 110A-N. For example, such clients can connect to the portal 130 by a variety of technologies, including private or public networks, such as the Internet. Any of a variety of device types can execute the client applications, which can execute under a variety of operating systems and environments. Consumers (e.g., natural persons) can employ such clients 110A-N to avail themselves of the technologies described herein. In practice, a single consumer can use different clients to access the technologies described herein while preserving the impression of a single, rationalized portal that stores and presenting information embodying the integrated private office of the consumer.

In the example, the integrated private office portal 130 has access to provider data collection 155 and consumer data collection 157, which includes information 158 about contracts. Thus, the consumer data collection 157 can track contracts (e.g., information regarding recurring payments under the contracts, a renewal date for a contract, or the like) between subscribing consumers and participating service providers. In practice, the contract information 158 need not actually be stored in the data collection. For example, it can be stored via a reference or link to the data. Or, separate contract information can reference the consumer data 157. In practice, the data collection can take the form of one or more databases, whether structured, unstructured, relational, flat, or the like.

In the implementation shown, the integrated private office portal 130 comprises cloud platform functionality 140. Other functionality can be included as described herein to provide a real-time, in-memory, mobile platform by which the integrated private office technologies are delivered.

The integrated private office portal 130 can include a wide variety of functionality, including contract administration, contract management, a social media channel, financial management, access management, reminder management, inbox management, cash flow management, goods management, and financial analytics.

A cash flow engine 160, and a plurality of plug-ins 170A-N of different plug-in types can also be implemented. In practice, there can be multiple instances of the same plug-in type. Although homogenous plug-in types are shown per industry group, the plug-ins types can be heterogeneous or otherwise customized as desired.

As shown, the integrated private office portal 130 can support a plurality of service providers 181A-185N across a plurality of industry group types 180A-N.

A social network provider can be included as described herein to provide social-network-specific functionality to enable communication between one single consumer and respective providers without being visible to others.

In practice, the systems shown herein, such as system 100 can vary in complexity, with different functionality, components of differing complexity, and the like. For example, in practice, cloud platform 140 can comprise a variety of other functionality not shown to address locality of information, synchronization, security, and the like.

Although various components of the systems herein are shown as a single component, in practice, the boundaries between components can be changed. For example, in practice, the portal 130 can be implemented across one or more machines, virtual or physical. Functionality can be distributed among such machines (e.g., to clients, server, or the like) as desired. Additional features relating to security, load balancing, and redundancy can also be included.

The system 100, any of the other systems described herein, and subsets of such systems can be implemented in conjunction with any of the hardware components described herein, such as the computing systems described below (e.g., processing units, memory, and the like). In any of the examples herein, the inputs, outputs, data collections, databases, contract representations, mapping data structures, and the like can be stored in one or more computer-readable storage media or computer-readable storage devices. The technologies described herein can be generic to the specifics of operating systems or hardware and can be applied in any variety of environments to take advantage of the described features.

### Example 3

### Example Method Implementing Integrated Private Office Technologies

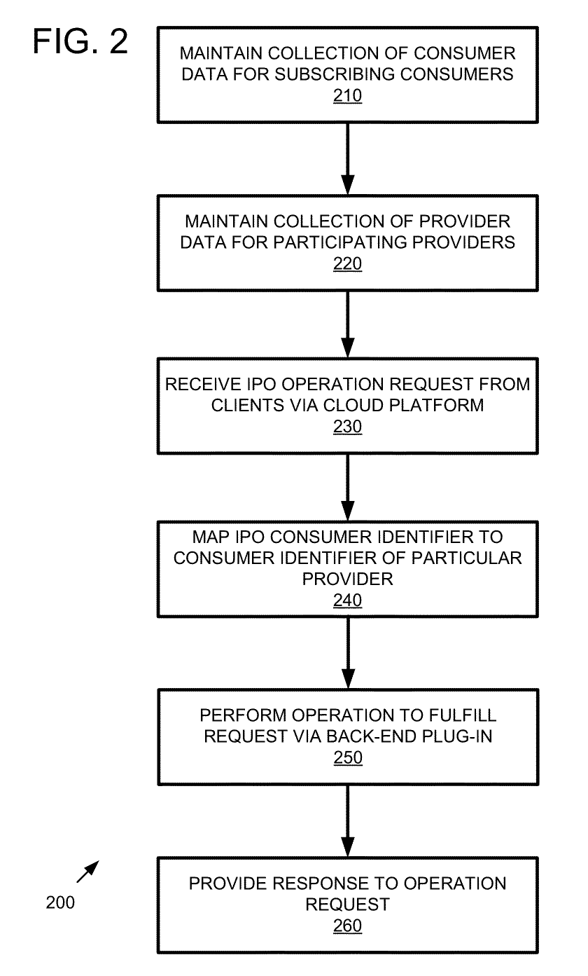

FIG. 2 is a flowchart of an example method 200 of implementing an integrated private office and can be implemented, for example, in the system shown in FIG. 1. As with the other methods described herein, the order of the acts can be changed while still implementing the described technologies.

At 210, a collection of consumer data is maintained for subscribing consumers. As described herein, such information can include a representation of the contracts that a consumer has entered into with service providers. In practice, the technologies can support a large number of consumers at a global scale. If desired, physical storage of information can be contained to a particular geographical or political area to comply with local laws or consumer expectations.

At 220, a collection of provider data for participating service providers is maintained. In practice, such information can include network addresses, protocol conventions, and the like for use in conjunction with the described plug-ins. The providers can be given an analytical overview of their customers, the contracts, new business, change business, cancelations, recorded advertising, recorded offers, offer status (e.g., declined, or not answered, etc.), and can control what to do next.

At 230, an integrated private office operation request is received from a client (e.g., on behalf of a subscribing consumer represented by a consumer identifier) via a cloud platform (e.g., the integrated private office portal). Such operation requests can vary widely as described herein and can take the form of a relationship information request, initiation of a subscription to services provided by a service provider, cancelation of a contract with a service provider, a request for an overview of contracts, a request for a visual presentation of cash flow, a request to execute or schedule a payment, setting up a direct debits, and the like. Search functionality can also be supported. Management can include such functions as initiating new relationships, evaluating past expenses, projecting future payments, or the like.

The operation request can be associated with (e.g., contain, refer to, or the like) an integrated private office consumer identifier of a particular subscribing consumer.

At 240, the integrated private office consumer identifier is mapped to a consumer identifier of a particular provider. As described herein, a mapping data structure can be maintained to assist in the mapping process. Such a mapping data structure can be separate or incorporated into other data structures (e.g., the contract data structure described herein). Also as described herein, such mapping can be done in advance (e.g., information is already available and need not be retrieved responsive to the request).

At 250, an operation is performed to fulfill the request via a back-end plug-in. In practice, data can be obtained ad hoc (e.g., on demand) or in advance. Such details can be handled by the cloud platform and database services. The plug-ins described herein can be employed. The operation can be performed via the consumer identifier of the particular provider involved. In practice, a single request can result in multiple mappings and multiple service providers. An operation can be performed via one of a plurality of different plug-in types (e.g., or multiple plug-ins as appropriate) supported by the integrated office portal.

At 260, a response to the operation request is provided. For example, if a request to show projected cash flow is received, information from multiple providers can be integrated as described herein, and a visual depiction of cash flow can be sent to the client for presentation.

The method 200 and any of the other methods described herein can be performed by computer-executable instructions (e.g., causing a computing system to perform the method) stored in one or more computer-readable media (e.g., storage or other tangible media) or stored in one or more computer-readable storage devices.

### Example 4

### Example Sources of Information

In any of the examples herein, an integrated private office can integrate a wide variety of information coming from a variety of sources. Such an approach can provide a level of completeness and transparency that multiplies the usefulness of the technologies, which can be enhanced by the consumer without notice to the provider.

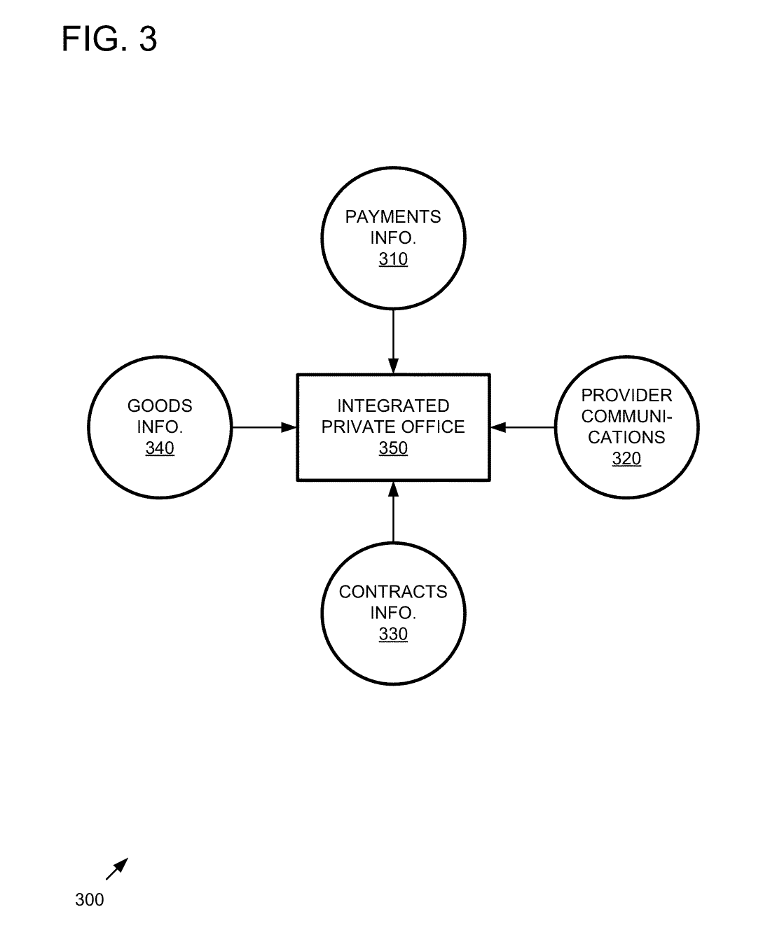

FIG. 3 is a block diagram of an example integrated private office system 300 integrating a variety of information. In the example, payments information 310, provider communications 320, contracts information 330, and goods information 340 are integrated into the integrated private office 350.

Further information, such as bank access or accounts, cash flow, quick access, reminders, and contracts can also be integrated.

The payments information 310 can include information on past, present, and future payments (e.g., amount, date, service provider, description, category, and the like). The information sufficient to make a payment can be included so that the payment itself can be scheduled and made via the office 350.

The provider communications 320 can include communications about upcoming payments, deadlines for renewing contracts, and the like. In addition to communications for directly managing current relationships, communications can include offers (e.g., advertisements or the like) from service providers to extend, upgrade, discount, or otherwise enhancing, building, continuing, or initiating a new relationship with a service provider. Such communications can include user interface elements that can be activated to initiate new relationships or modify existing ones.

The contracts information 330 can track a wide variety of contract types as described herein. Recurring payment information can be stored to assist in managing cash flow. Particulars of the contract can be represented to assist in providing a complete picture of the consumer's financial situation can be stored. For example, documents that embody the contract can be stored. Such documents can be accessed as described herein.

The goods information 340 can store information, manuals, and the like, about goods owned by a consumer. For example, information about goods and assets such as an automobile, real estate, collectables, consumer electronics, and the like can be stored. Although automatic population of such information can be accomplished, the office 350 can also accept manual entry of such information. For example, a fillable form can be provided by which a consumer can manually enter information such as asset type, description, value, purchase date, warranty, depreciation, and the like. Such information can then be integrated into the total picture by the integrated private office for the consumer. In this way, a consumer can consult such information at a later time without having to maintain a paper record. Electronic documents can further be attached with an item and recalled afterwards.

### Example 5

### Example Method Implementing Integrated Private Office

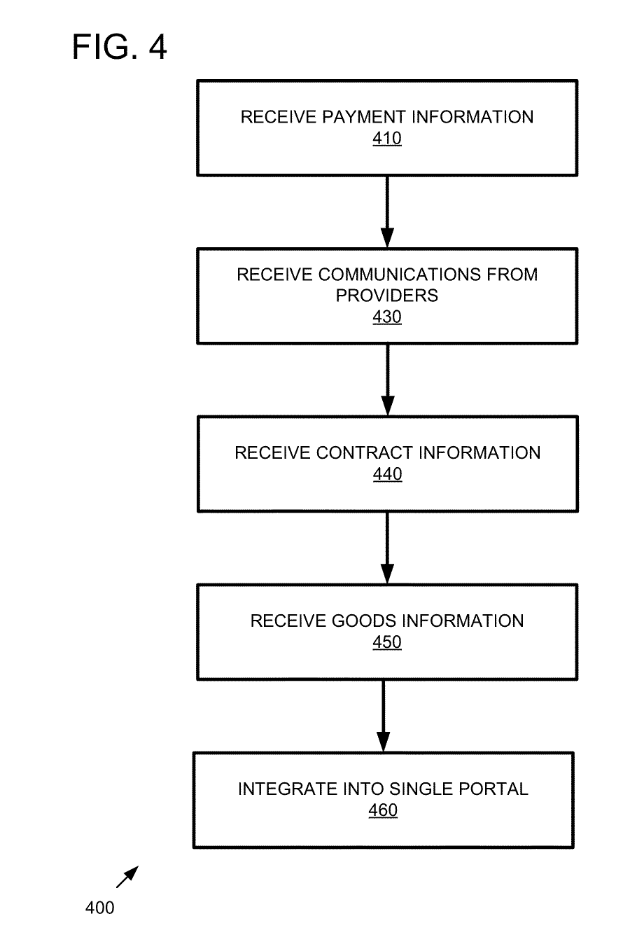

FIG. 4 is a flowchart of an example method 400 implementing an integrated private office integrating a variety of information and can be implemented, for example, in the system 300 of FIG. 3 or the system 100 of FIG. 1 and can accomplish the technology described for FIG. 2.

At 410, payment information is received by the integrated private office portal.

At 430, communications from providers are received from service providers by the integrated private office portal.

At 440, contract information is received by the integrated private office portal.

At 450, goods information is received by the integrated private office portal.

At 460, the received information is integrated into a single portal for presentation to participating users. For example, as described herein, a consumer can navigate between different user interfaces that present the information in a unified way. Further integration can be done to present a complete financial picture for the consumer.

### Example 6

### Example Integration

As described herein, the integrated private office can be integrated into different systems of provider system landscapes. For example, human resources, financial, or other systems can be run in the private or public cloud alongside the integrated private office system. Plug-ins, such as Personal Finance Manager Personal Insurance Manager, Personal Utility Manager, and the like can make sure that industry-specific content is visible to the consumer, providing a 360-degree view on their own portfolio.

As described herein, a variety of integration techniques can be employed to provide useful information to consumers.

For example, a cash flow visualization can comprise integrating cash flow impacts (e.g., income, expenses, investments, or combinations thereof occurring at a particular time or period) originating from contracts with a plurality of service providers.

Integration can also take the form of taking a single action across service providers. For example, a consumer can change physical address, change name, change phone number, change electronic contact information, or the like. Service address changes for a plurality of service providers by a consumer can also be accomplished (e.g., when a consumer moves, a single operation can result in notifications and change orders to a plurality of service providers, such as water company, electric company, trash removal, or the like).

Integration can also take the form of comparative analysis. For example, for a new automobile purchase, the impact on cash flow (e.g., increase in monthly payment versus gas economy) can be evaluated, either prospectively or after the purchase.

A data manager can be configured to manage consumer data across a plurality of the service providers, allowing multiple operations to be performed via a single indication.

### Example 7

### Example Operations

Contracts between different providers and consumers can be transferred between the providers and consumers, including an electronic signature by the provider, consumer, or both. Credit and debits of multiple accounts of consumers (e.g., bank accounts as well as guarantees, mileage accounts, point accounts, and the like) are accessible for consumers. Providers are only able to view their own consumers' accounts without having a view to the aggregate account information of a consumer.

Reminders for consumer action can be published, and maintenance of reminders by the consumer can be incorporated. Advertising in terms of consumer advantage, offers, and the like, paid by the providers can provide benefits when communicating electronically. The paperless office can be supported by multiple tasks that a consumer can do to enrich the integrated private office by supporting consumer enhancements through maintenance of reminders, quick access to different platforms, storing manuals of goods, an inbox, communication with providers, and the like.

In any of the examples herein, the integrated private office can accept and implement and trigger a variety of operation requests, thereby implementing a virtual private office. For example, the technologies can implement a relationship information request, initiation of a subscription/contract to/for services provided by a service provider, cancelation of a subscription/contract with a service provider, a request for an overview of contracts, a request for a visual presentation of cash flow, a request to execute or schedule a payment, setting up direct debits, and the like. Further operations can include communicating with providers, membership and newsletter subscription and cancellations, changing personal data and extending contracts, viewing salary information, optimizing and enhancing a personal portfolio, and the like. Special offers can be sent to consumers, and private business transactions can be managed to digitize the communication between provider and consumer.

Search functionality can also be supported so that a consumer can search the integrated private office to find wanted information.

Management functionality performable via operations can include such functions as initiating new relationships, evaluating past expenses, projecting future payments, or the like.

Social media operations can also be accomplished, such as publishing events related to new relationships, how current relationships are progressing, extending invitations to others to join a service provider (e.g., referrals), and the like.

As described herein, performing a requested operation can comprise integrating data from a plurality of providers having different plug-in types tailored to different industries.

### Example 8

### Example Industry Group Types

In any of the examples herein, a wide variety of industries (e.g., industry group types) can be included as service providers, such as utilities (e.g., electric utilities, water utilities, trash collection, or the like), finance companies (e.g., banks, consumer loan companies, mortgage companies, brokers, investment houses, or the like), insurance companies, energy companies (e.g., oil and gas companies, filling stations, recharging stations, or the like), media, telecommunication, subscription providers, social media, public organizations, employers, and many others to provide a single place for consumers to act. An n:m relationship between n providers and m consumers having a different portfolio and providers can be implemented.

The integrated private office can also integrate with a consumer's employer. For example, expected earnings, projected bonuses, business expense reimbursement, and the like can be supported. An employer can thus be a participating service provider in the system.

### Example 9

### Example Implementation via Plug-in

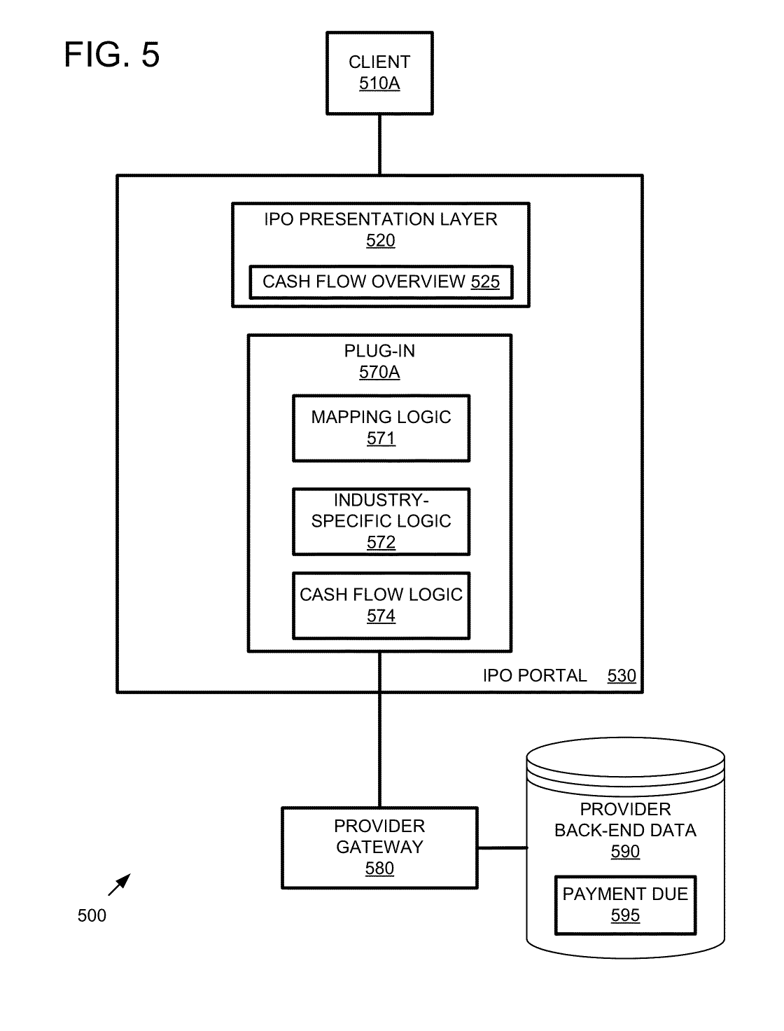

FIG. 5 is a block diagram of an example integrated private office portal 500 implementing an integrated private office portal via an industry-specific plug-in 570A.

In the example, a client 510A accesses the integrated private office portal 530 via the technologies described herein. An integrated private office presentation layer 520 can present various user interfaces to the client 510A. As described herein, a presentation of cash flow overview 525 or any of a variety of other user interfaces can be included.

In any of the examples herein, the integrated private office portal 530 can comprise a plug-in 570A. Such a plug-in can comprise mapping logic for mapping provider information to integrated private office information as well as the communication channel on social media that a consumer and provider can use to communicate.

In the example, the plug-in 570A is specific to a particular industry. For example, a finance company may process loans and have a particular way of storing and communicating such information. The plug-in 570A can include mapping logic 571 for mapping as described herein; industry-specific logic 572 can handle integration of loan processing information into the integrated private office. Similarly, cash flow logic 574 can include functionality for interfacing with the integrated private office portal to indicate upcoming cash flow needs.

Further functionality of the plug-in 570A can include communication channel logic and contract logic.

General (e.g., non-industry-specific) plug-ins can be provided to perform common functionality.

In practice, the portal 530 can communicate via a provider gateway 580 to receive provider back-end data 590, which can include information that is to be integrated into the portal 530, such as information 595 about a payment due, for example. the payment due information 595 can be integrated into the office by affecting the cash flow overview 525 (e.g., depicted as an upcoming expense). Contract logic as well as electronic signature functionality can be provided via a plug-in. Such a plug-in can be provided to providers for a fee.

### Example 10

### Example Method with Plug-In

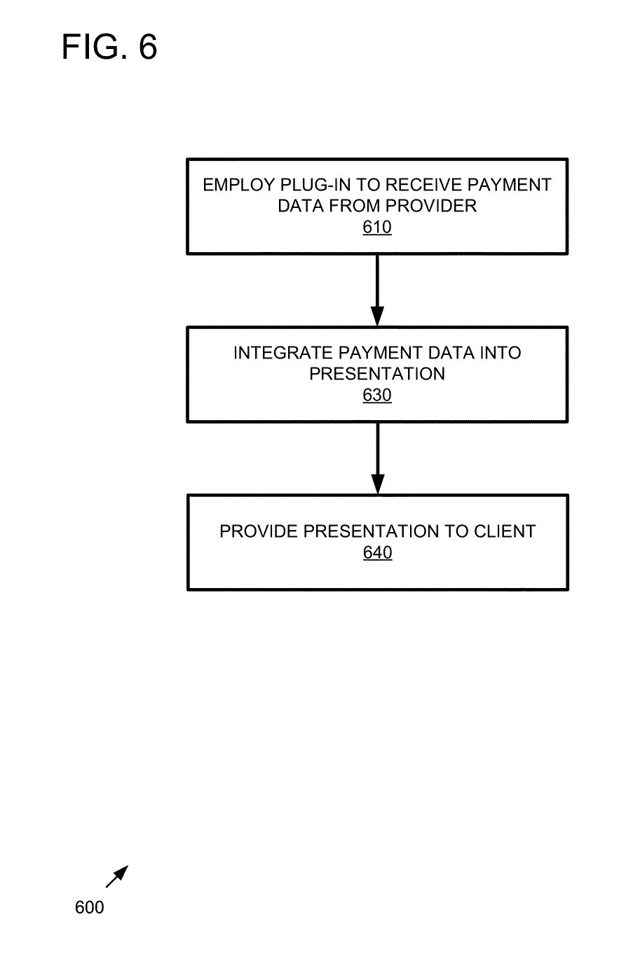

FIG. 6 is a flowchart of an example method 600 implementing an integrated private office portal via an industry-specific plug-in involving payment data.

At 610, a plug-in is employed to receive payment data from a service provider.

At 630, the payment data is integrated into a presentation (e.g., a cash flow overview presentation as part of a user interface as described herein). In practice, other types of information can originate from the plug-in and be integrated.

At 640, the presentation is provided to a client, a consumer. As shown herein, such a presentation can be a cash flow or other user interface for consideration and manipulation by a user.

### Example 11

### Example Plug-Ins

In any of the examples herein, a plug-in can be provided to assist in integrating a participating service provider's interaction with the integrated private office technologies.

Certain industries may have accepted technologies for communicating financial or other information. A plug-in can serve to interact with a service provider via such technologies and rationalize the data across industries into an integrated format that can be used to perform the operations described herein.

An example of such a plug-in is a financial contract accounting component that tracks what are they payments related to a contract, cancelation terms, and the like. Small businesses can be provided a way to interface with a plug-in as part of an enterprise resource planning or other enterprise software.

Other functionality can be provided by a personal finance manager, a personal utility manager, or other personal manager. To encourage a wide variety of participating service providers, solutions from third parties can be supported.

Social media plug-ins for communication between a consumer and provider, electronic signature plug-ins to perform contracts initiation, contractual change, contractual cancelation, contractual extension, and so forth can be provided as standard plug-ins. The provider can be charged for access to such plug-ins.

### Example 12

### Example Architecture for Integrated Private Office

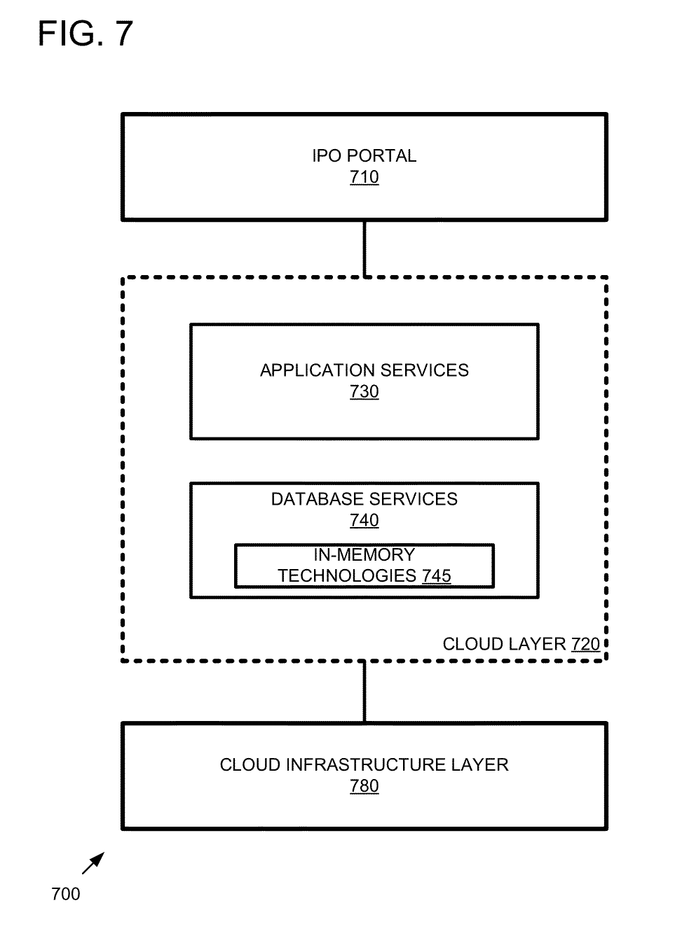

FIG. 7 is a block diagram of an example architecture 700 for supporting an integrated private office portal 710.

In the example, the integrated private office portal 710 sits on top of a cloud layer 720 that provides various services that can be leveraged by the portal 710. The layer 720 can comprise application services 730 and database services 740. As described herein, the database services 740 can include in-memory technologies 745 that implement columnar, in-memory database techniques to provide superior performance for the user experience when accessing the portal 710. The technologies can be provided as a platform-as-a-service scenario optimized for a wide audience of developers building cloud applications. Database-as-service offerings can allow strong database performance.

A cloud infrastructure layer 780 can work in concert with the cloud layer 720 to provide a rich set of user interface features across a variety of device types. Cloud enablement services can provide access to commonly-used services for tenant management, administration, monitoring, and the like. Real-time process integration, data integration, and prepackaged integration flows can be included or supported.

On-premise, off-premise, and third party cloud solutions can be successfully integrated (e.g., as a plug-in) into the integrated private office. Analytical and mobile features can be used for production of plug-ins for integrated private office providers who can determine which they wish to use for the business with the consumers.

### Example 13

### Example User Interface Layout

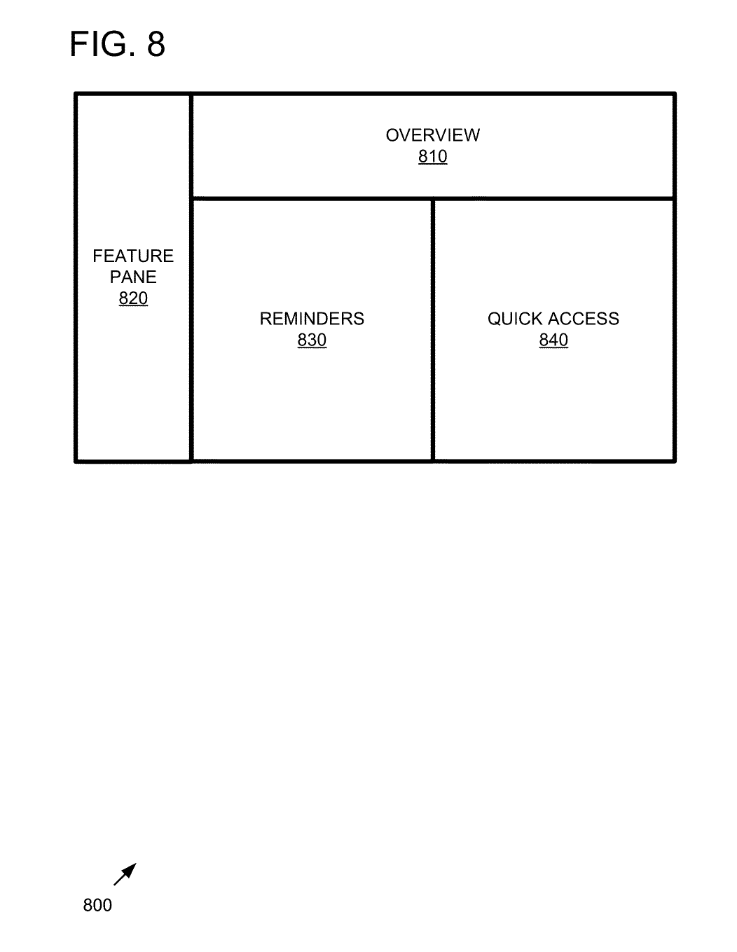

In any of the examples herein, a user interface 800 for presenting an integrated private office can use the layout shown in FIG. 1n FIG. 8. Although any of a variety of other arrangements are possible, the example can be useful for users to see a total picture at a glance. A consumer can personalize the layout and determine which elements are to be shown.

The user interface 800 comprises an overview pane 810. The overview can take a variety of forms as configured by the consumer. For example, a “My Cash Flow” pane can present an overview of cash flow as described herein.

The user interface 800 can further comprise a feature pane 820 that lists a variety of features available to the user (e.g., overview, payments, contracts, goods, inbox, analytics, reminder, access, or the like). Activation of a user interface associated with the feature navigates to a user interface by which the consumer can use the feature.

Also included can be reminders pane 830 that can be driven by a reminder engine operable to present one or more reminders. Such reminders can include upcoming renewals that are due (e.g., a reminder to renew a homeowner's insurance policy), terms of guarantee that are ending (e.g., a television provider), expiration of a credit agreement, ending of a cancelation period, meetings (e.g., club meetings), and the like. Thus, in any of the examples herein, a reminder that a contract is near expiration can be provided via the integrated private office portal.

Activation of a user interface element or area associated with the reminder can display more details and provide a user interface for addressing an action item related to the reminder. For example, an indication that a contract is to be renewed can be accepted. Responsive to the indication, renewal processing can execute renewal of the contract. If further information is needed, it can be obtained via a user interface and/or automatically filled in based on the consumer data collection. Thus, the indication that the contract is to be renewed can be accepted via the user interface activated via the reminder that the contract is near expiration.

A user interface element can be provided to add new items, delete items, or change items.

A quick access pane 840 can also be provided. A consumer may choose, or the system may discern certain items that are frequently accessed (e.g., consumer service contact information, a consumer identifier for a particular service provider, a link to an electricity meter, a retail account, a bank account, an insurance account, or the like). A user interface element can be provided to add new items, delete items, or change items.

### Example 14

### Example User Interface for Cash Flow

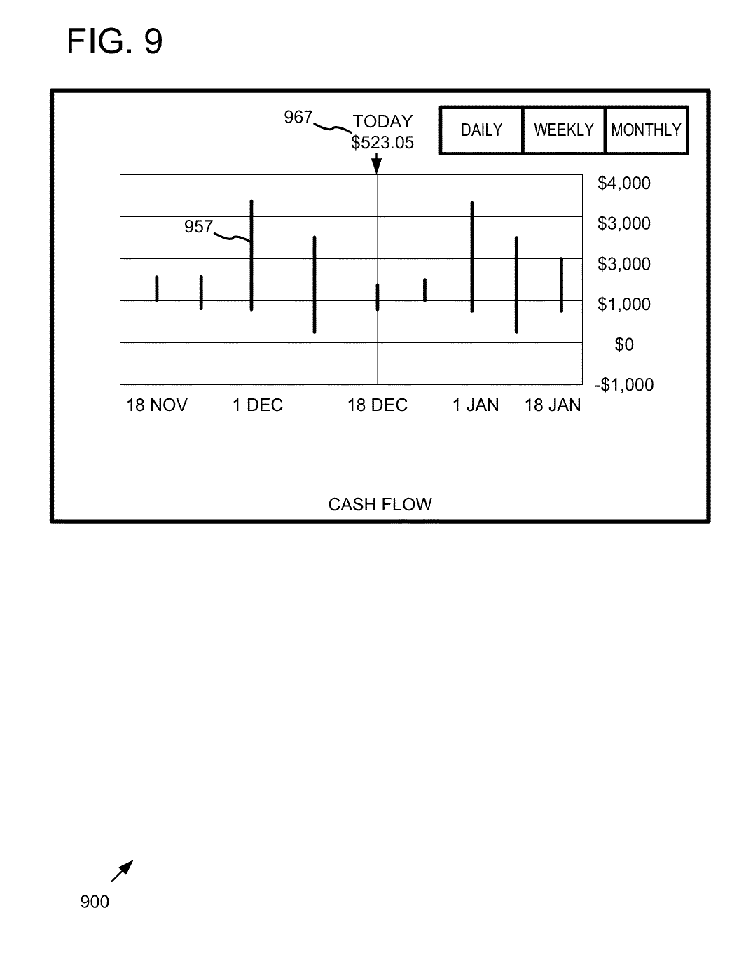

FIG. 9 is a screen shot of an example cash flow user interface 900 for presentation as part of an integrated private office that can be used in any of the examples herein.

In the example, past, present, and future cash flow is shown in a single user interface. Multiple bank accounts can be included in the condensed cash flow overview, which can be aggregated on a yearly, monthly, weekly, or daily basis. Cash flow bars 957 can indicate a variety of information related to cash flow. In the example, the bar can comprise segments of different colors being of a length (e.g., corresponding to a dollar amount) that can denote any of the following:

| | |
|---|---|
| Color 1 (e.g., blue) | Current level of cash |
| Color 2 (e.g., green) | Known income |
| Color 3 (e.g., red) | Known expenses |
| Color 4 (e.g., light green) | Estimated or likely income (e.g., bonus) |
| Color 5 (e.g., light red) | Estimated or likely expenses (e.g., vacation) |

The segments can be combined in a single bar, the cumulative impact of which is reflected in the subsequent bar (e.g., if expenses exceed income, the current cash level for the next period decreases).

Options to show daily, weekly, monthly, or the like periods can be supported. To place emphasis on the current available cash level, a center marker 967 can point to the current level and indicate it in explicit numerical format.

Although dollars are shown, the portal can easily be customized to handle other currencies (e.g., euros, yen, rupees, or the like). Mixed currencies can be supported via current exchange rate information.

The user interface can be particularly helpful because it can integrate cash flow information from a variety of sources, including different industries, different, providers, different bank accounts, consumer personalization, and the like. As described herein, manual entry can also be supported to supplement the information. For example, a form can be provided by which periodicity, amount, provider name, description, and related documents are provided via manual indication. The details of the consumer-provider contract can then be integrated into the integrated private office.

### Example 15

### Example User Interface for Cash Flow with Inset

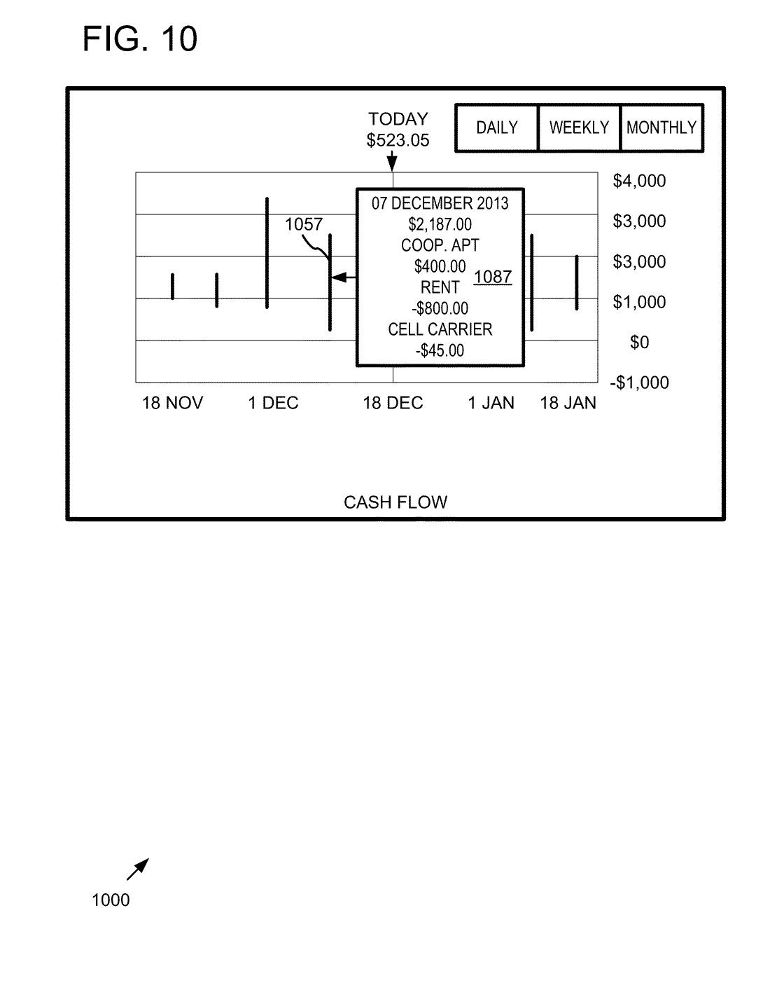

FIG. 10 is a screen shot of an example cash flow user interface 1000 with a detail inset 1087. The interface 1000 is depicted as an enhanced version of the user interface 900 shown in FIG. 9, but can be incorporated into other scenarios as desired.

The inset 1087 can be presented responsive to selection or activation of a particular bar 1057 in the user interface.

As shown, the inset 1087 can present a summary of the cash flow events relating to the bar (e.g., relating to the time period associated with the bar 1057. For example, a date associated with the time period and a summary of incoming and outgoing cash flow can be included. In the example, two income and two expense events are shown. Color can be used to distinguish the two. If desired, further information can be obtained by activating particular text within the inset (e.g., to navigate to event details or a summary of the involved account, or both).

Such a feature can be particularly helpful to obtain further detail for a particular time period. For example, a user may see an unexpected variance or event and easily drill down to the details involved.

Thus, the functionality across contracts described herein can comprise generating a user interface depicting projected cash flow over time via combining the payment and other information obtained via a plurality of plug-in types for different service providers as well as standard plug-ins available online (e.g., over the Internet).

### Example 16

### Example Contracts Overview User Interface

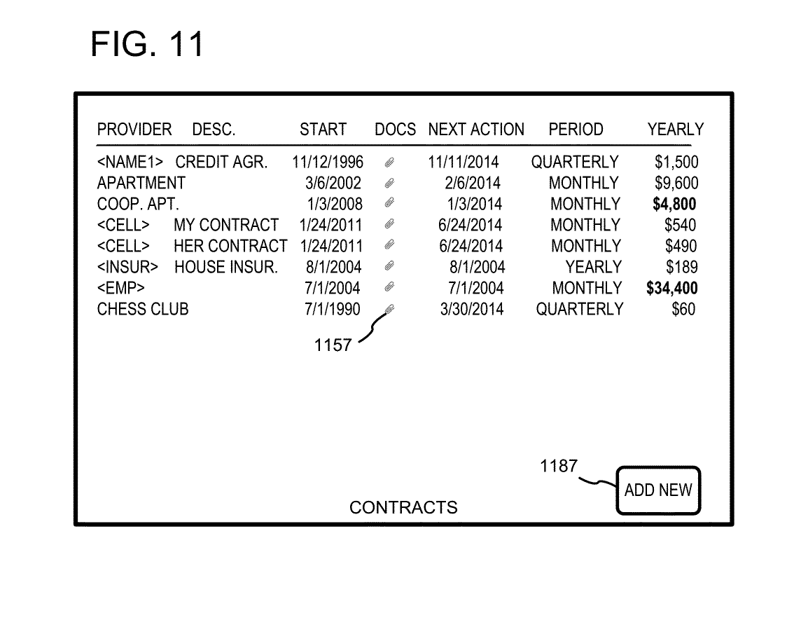

FIG. 11 is a screen shot of an example contracts overview user interface 1100 for presentation as part of an integrated private office. The user interface 1100 can provide o helpful way for a consumer to see an overall summary of current business relationships and relevant high level data concerning them. Further information for a particular relationship can easily be obtained as described herein. Deep dive functionality can be provided.

In the example, a service provider name, description, start, next action, period, and yearly cash flow impact of the relationship is shown. As shown, a variety of provider types, including credit agencies, real estate, land lord, cell phone providers, insurance, banks, employers, clubs, medial, utilities, and the like can be included.

Responsive to a request to provide an overview of contracts, an overview of a plurality of contracts for a consumer can be assembled. As shown, the overview can comprise a provider name for the contract, a description of the contract, and one or more links to documents for respective of the contracts. Such an overview can be sent to a client for presentation as part of a user interface. As described herein, cloud infrastructure can tailor the presentation to a particular device type. A yearly payment impact for respective of the contracts can be calculated and provided as part of the overview.

The summary for a particular contract can include a link 1157 that navigates to a user interface by which documents (e.g., an agreement, brochure, or the like) related to the contract are shown.

Activation of a summary line for a particular contract can navigate to further details (e.g., a running list of transactions, contact information, or the like).

A user interface element 1187 can be included that allows addition of a new contract. For example, a consumer can select a known provider or be presented with competing offers from different providers for a particular service. Thus, a relationship with a new provider can be initiated via the interface 1100.

Responsive to receiving an indication that a new contract is to be added for the consumer, a list of competing providers for a particular industry can sent for display at the client. A selection of a particular provider out of the competing service providers can then be received, and the relationship with the service provider can then be initiated. For example, information already available within the office can be used to pre-fill forms that are part of the relationship initiation workflow. In this way, private details can be stored in the integrated private office.

### Example 17

### Example Inbox

In any of the examples herein, an inbox or other mechanism can be provided by which a service provider can communicate with a consumer. The consumer can set preferences limiting communications to those service providers with which the consumer already has a relationship.

Thus, in any of the examples herein, a communication can be sent to a consumer for a contract. Such a communication can provide an offer to the consumer regarding the contract (e.g., to extend, upgrade, enhance, switch, modify, or otherwise affect the contract). An electronic signature can be implemented to sign contracts, extend contracts, change contracts, cancel contracts, and the like.

The integrated private office can receive communications targeted to a plurality of consumers on behalf of the service providers. Thus, the integrated private office can serve as an advertising platform for commercial providers.

Personalization for consumers allows configuration of the user interface in the way the consumer prefers by adding, changing, and deleting parts of a standard user interface so the consumer can focus or enhance their own user experience.

### Example 18

### Example Mapping Data Structure for User Identities

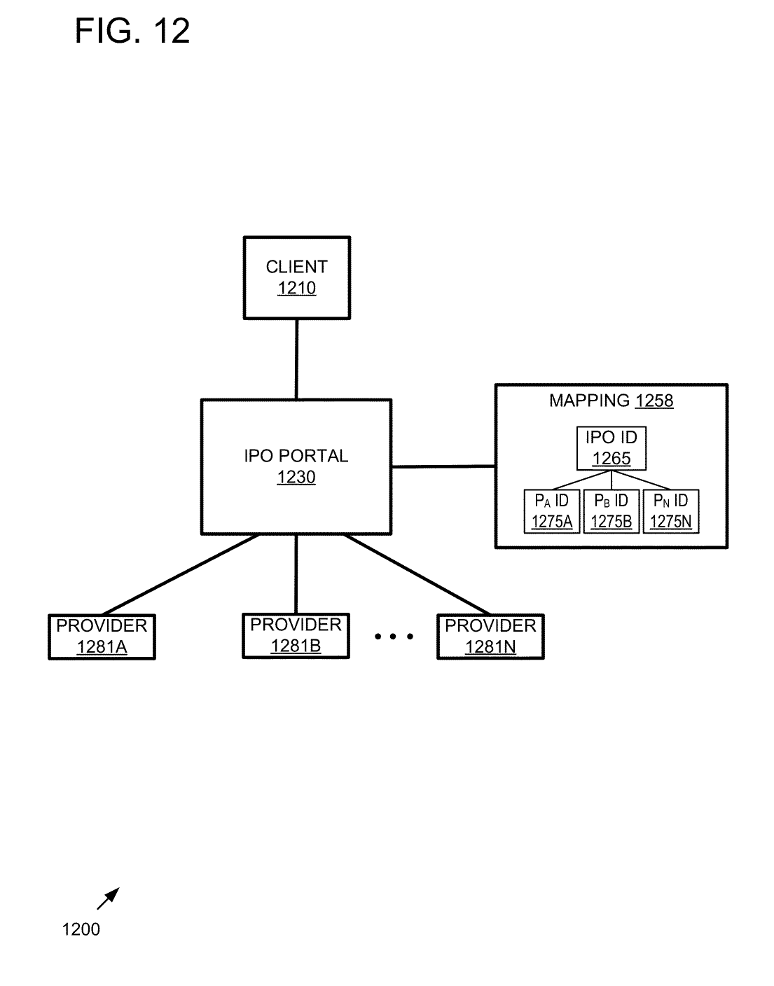

FIG. 12 is a block diagram of a system 1200 comprising a mapping data structure 1258 used to resolve user identities for a single user across multiple providers.

In the example, a single consumer accesses the integrated private office portal 1230 via a client 1210. In practice, a consumer can user a plurality of clients (e.g., of different device types) while still maintaining a single identity (e.g., username and password associated with the integrated private office).

Although the service providers 1281A-1281N may have different respective consumer identifiers 1275A-1275N for the consumer, a single consumer identifier 1265 can be used to represent the consumer across the integrated private office portal 1230. To assist in mapping between the identifiers, a mapping data structure 1258 can associate the integrated private office identifier 1265 with respective of the different consumer identifiers 1275A-1275N maintained by the providers 1281A-N. The mapping can ensure that the right connection between consumer and provider is identified.

Although shown as storing a single instance of the integrated private office consumer identifier 1265, in practice, mapping can be accomplished by storing the identifier 1265 multiple time (e.g., in different records).

The mapping can be achieved in a number of ways. For example, a relational database, in-memory database technologies, hash tables, lookup tables, or the like can be employed. Related mapping functionality can accept a consumer identifier maintained by a particular provider and a provider identifier as input and provide an integrated private office (e.g., globally unique across the integrated private office) identifier in return. Similarly, mapping functionality can accept an integrated private office identifier and a provider identifier and return a consumer identifier for a particular provider in return.

Mapping can be accomplished by contract rather than or in addition to provider. Thus, multiple contracts per provider can be supported for a single consumer. For example, a contract record as described herein can comprise the integrated private office identifier and the corresponding service provider identifier.

Further, the mapping can be done at the time an operation request is made, in advance of such a request, or both.

In some embodiments, providers can only communicate with their consumers and vice versa, as the communication streams and data are based on an existing or emerging contractual relationship. Consumers can set preferences to indicate that they only want communications from providers with which they already have a relationship.

### Example 19

### Example Data Structure Representing Contracts

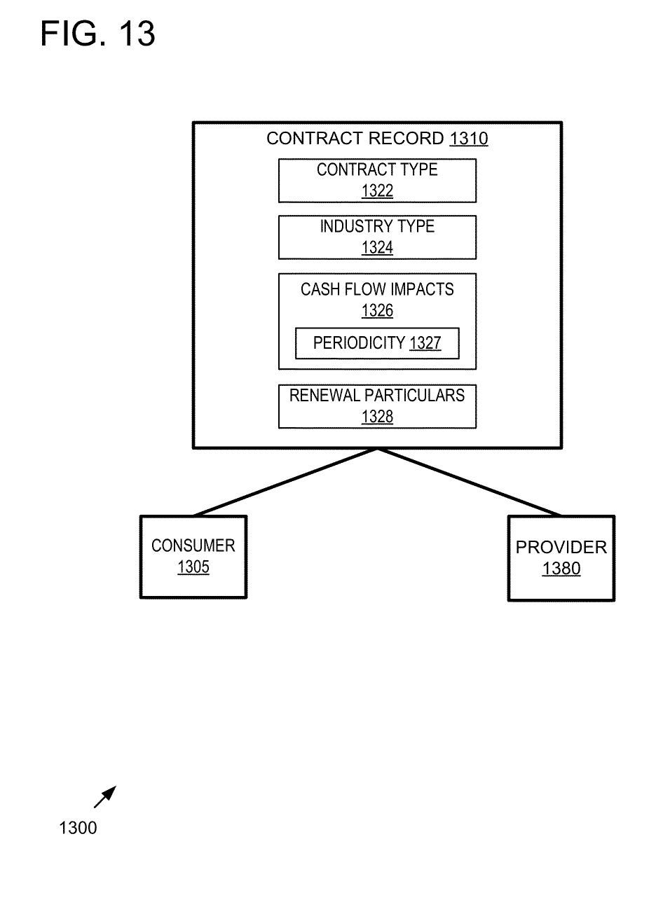

FIG. 13 is a block diagram of an integrated private office system 1300 comprising a contract record data structure 1310 that can be used in any of the examples herein.

In the example, a relationship between a consumer represented by a consumer identifier 1305 and a service provider represented by a provider identifier 1380 can be represented as a contract record data structure 1310.

Contract information can include an electronic signature by either one side or both sides of the contract (e.g., signed electronically by consumer, provider, or both).

In the example, the contract record 1310 comprises a contract type 1322, an industry type 1324, cash flow impacts 1326, including periodicity 1327 (e.g., recurring payments occurring under the contract, such as monthly, quarterly, or the like), and renewal particulars 1328. Other information, such as a contract identifier or the like can be included as appropriate. Providers are able to send signed contracts by electronic signature to the consumers to be re-signed by the consumers electronically. Signed contracts of both sides as well as signed contracts by providers only can be stored in the contract record.

The information stored in the record 1310 can be synchronized with provider maintained data using the database technologies described herein. The actual data and consumer/provider identifiers can be stored internal or external (e.g., via links) to the data structure. Consumer identifier mapping as described herein can be implemented as part of the record or be performed separately.

Although the word “record” is used, in practice, the information need to be confined to representation as a database record. Similarly, although the term “database” is used, in practice, the data can be distributed among a plurality of databases that is treated as a single, logical database.

### Example 20

### Example Computing Environment

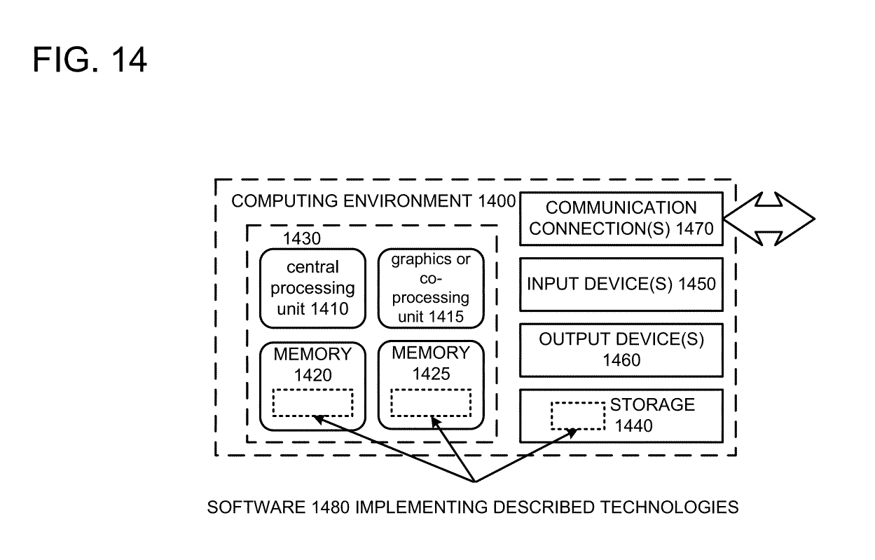

FIG. 14 depicts a generalized example of a suitable computing environment (e.g., computing system) 1400 in which the described innovations may be implemented. The computing environment 1400 is not intended to suggest any limitation as to scope of use or functionality, as the innovations may be implemented in diverse general-purpose or special-purpose computing systems. For example, the computing environment 1400 can be any of a variety of computing devices (e.g., desktop computer, laptop computer, server computer, tablet computer, etc.).

With reference to FIG. 14, the computing environment 1400 includes one or more processing units 1410, 1415 and memory 1420, 1425. In FIG. 14, this basic configuration 1430 is included within a dashed line. The processing units 1410, 1415 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 14 shows a central processing unit 1410 as well as a graphics processing unit or co-processing unit 1415. The tangible memory 1420, 1425 may be volatile memory (e.g., registers, cache, RAM), non-volatile memory (e.g., ROM, EEPROM, flash memory, etc.), or some combination of the two, accessible by the processing unit(s). The memory 1420, 1425 stores software 1480 implementing one or more innovations described herein, in the form of computer-executable instructions suitable for execution by the processing unit(s).

A computing system may have additional features. For example, the computing environment 1400 includes storage 1440, one or more input devices 1450, one or more output devices 1460, and one or more communication connections 1470. An interconnection mechanism (not shown) such as a bus, controller, or network interconnects the components of the computing environment 1400. Typically, operating system software (not shown) provides an operating environment for other software executing in the computing environment 1400, and coordinates activities of the components of the computing environment 1400.

The tangible storage 1440 may be removable or non-removable, and includes magnetic disks, magnetic tapes or cassettes, CD-ROMs, DVDs, or any other medium which can be used to store information in a non-transitory way and which can be accessed within the computing environment 1400. The storage 1440 stores instructions for the software 1480 implementing one or more innovations described herein. For example, the rules engine and others described herein can be the software 1480 executed from the memory 1420.

The input device(s) 1450 may be a touch input device such as a keyboard, mouse, pen, or trackball, a voice input device, a scanning device, or another device that provides input to the computing environment 1400. The output device(s) 1460 may be a display, printer, speaker, CD-writer, or another device that provides output from the computing environment 1400.

The communication connection(s) 1470 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although direct connection between computer systems is shown in some examples, in practice, components can be arbitrarily coupled via a network that coordinates communication.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

### Example 21

### Example Cloud-Supported Environment

In example environment 1500, the cloud 1510 provides services for connected devices 1530, 1540, 1550 with a variety of screen capabilities. Connected device 1530 represents a device with a computer screen 1535 (e.g., a mid-size screen). For example, connected device 1530 could be a personal computer such as desktop computer, laptop, notebook, netbook, or the like. Connected device 1540 represents a device with a mobile device screen 1545 (e.g., a small size screen). For example, connected device 1540 could be a mobile phone, smart phone, personal digital assistant, tablet computer, and the like. Connected device 1550 represents a device with a large screen 1555. For example, connected device 1550 could be a television screen (e.g., a smart television) or another device connected to a television (e.g., a set-top box or gaming console) or the like. One or more of the connected devices 1530, 1540, 1550 can include touch screen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1500. For example, the cloud 1510 can provide services for one or more computers (e.g., server computers) without displays.

Services can be provided by the cloud 1510 through cloud service providers 1520, or through other providers of online services (not depicted). For example, cloud services can be customized to the screen size, display capability, and/or touch screen capability of a particular connected device (e.g., connected devices 1530, 1540, 1550).

In example environment 1500, the cloud 1510 provides the technologies and solutions described herein to the various connected devices 1530, 1540, 1550 using, at least in part, the service providers 1520. For example, the service providers 1520 can provide a centralized solution for various cloud-based services. The service providers 1520 can manage service subscriptions for users and/or devices (e.g., for the connected devices 1530, 1540, 1550 and/or their respective users).

### Non-Transitory Computer-Readable Media

Any of the computer-readable media herein can be non-transitory (e.g., memory, magnetic storage, optical storage, solid-state drives, or the like).

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Media

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

### Methods in Computer-Readable Storage Devices

Any of the methods described herein can be implemented by computer-executable instructions stored in one or more computer-readable storage devices (e.g., memory, magnetic storage, optical storage, solid-state drives, or the like). Such instructions can cause a computer to perform the method.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

What is claimed is:

1. A method implemented at least in part by a computing system, the method comprising:
maintaining a collection of consumer data for a plurality subscribing consumers;
maintaining a collection of provider data for a plurality of participating providers;
via an integrated private office portal, receiving an integrated private office operation request from a client via a cloud platform, wherein the operation request is associated with an integrated private office consumer identifier of a particular subscribing consumer;
mapping the integrated private office consumer identifier to a consumer identifier of a particular one of the providers;
via the consumer identifier of the particular one of the providers, performing the requested operation via one of a plurality of different plug-in types supported by the integrated private office portal; and
providing a response to the integrated private office operation request to the client.

2. The method of claim 1 wherein:
performing the requested operation comprises integrating data from a plurality of providers having different plug-in types tailored to different industries.

3. The method of claim 1 wherein:
the requested operation comprises providing a cash flow overview; and
the method further comprises:
from a plurality of the participating providers, obtaining a plurality of cash flow impacts via the plurality of different plug-in types; and
integrating the cash flow impacts into a single cash flow overview.

4. The method of claim 1 wherein:
the collection of consumer data tracks contracts between subscribing consumers and respective of the providers.

5. The method of claim 4 wherein:
information for the contracts comprises information regarding recurring payments under the contracts.

6. The method of claim 4 further comprising:
assembling an overview of a plurality of contracts for the consumer, wherein the overview comprises a provider name, a description, and one or more links to documents for respective of the contracts; and
sending the overview to the client for presentation.

7. The method of claim 6 further comprising:
calculating a yearly payment impact for respective of the contracts; and
providing the yearly payment impact for respective of the contracts as part of the overview.

8. The method of claim 6 further comprising:
receiving an indication that a new contract is to be added for the consumer;
responsive to receiving the indication that a new contract is to be added, sending a list of competing providers for a particular industry for display; and
receiving a selection of a provider out of the competing providers.

9. The method of claim 4 wherein:
the collection of consumer data tracks a renewal date for a contract.

10. The method of claim 9 wherein the method further comprises:
via the integrated private office portal, providing a reminder that the contract is near expiration.

11. The method of claim 10 wherein the method further comprises:
via the integrated private office portal, accepting an indication that the contract is to be renewed.

12. The method of claim 11 wherein:
the indication that the contract is to be renewed is accepted via a user interface activated via the reminder that the contract is near expiration.

13. The method of claim 11 further comprising:
sending, via the integrated private office portal, a communication to a consumer for the contract, wherein the communication provides an offer to the consumer regarding the contract.

14. The method of claim 1 further comprising:
receiving a manual indication of a consumer-provider contract from the client; and
integrating details of the consumer-provider contract into the integrated private office.

15. The method of claim 1 further comprising:
via the integrated private office portal, receiving an indication of goods purchased by the consumer; and
integrating details of the goods purchased by the consumer into the integrated private office.

16. The method of claim 1 wherein:
the collections of data are managed via database technologies providing in-memory columnar database functionality.

17. A system comprising:
one or more processors; and
memory coupled to the one or more processors;
a consumer information data collection for a plurality of subscribing consumers, wherein the consumer information collection is organized via an integrated private office consumer identifiers;
a provider information data collection for a plurality of participating service providers;
a mapping between the integrated private office consumer identifiers and consumer identifiers for particular of the participating service providers;
representations of contracts between the subscribing consumers and the participating service providers; and
a cash flow analysis engine configured to integrate payment information arising out of the contracts for a plurality of the service providers into a cash flow overview presentation.

18. The system of claim 17 further comprising:
a reminder engine operable to present a reminder when a contract out of the contracts is nearing expiration;

19. The system of claim 17 further comprising:
a data manager configured to manage consumer data across a plurality of service providers.

20. One or more computer-readable media having encoded therein computer-executable instructions causing a computing system to perform a method comprising:
receiving payment information for a plurality of consumers on behalf of a plurality of service providers via a plurality of plug-in types;
receiving communications targeted to the plurality of consumers on behalf of the plurality of service providers;
receiving contract information for the plurality of service providers;
receiving goods information for the plurality of consumers;
integrating the payment information, communications, contract information, and goods information into an integrated private office portal, wherein the integrated private office portal provide a variety of functionality across contracts between the consumers and respective of the service providers, wherein the functionality comprises generating a user interface depicting projected cash flow over time via combining the payment information obtained via the plurality of plug-in types;
providing a social media channel between a consumer and a service provider;
storing electronic signatures for contracts entered into by the consumers;
employing an industry-specific plug-in and a standard plug-in;
providing paperless office functionality to the consumers;
providing user interface customization functionality; and
storing private business information for a consumer;
whereby a consumer-centric approach is implemented.
